(19) United States
(12) Patent Application Publication
(10) Pub. No.: US 2026/0291116 A1
(43) Pub. Date: Sep. 24, 2026

(54) CONNECTOR

(71) Applicant: Yazaki Corporation, Tokyo (JP)

(72) Inventors: Masaaki IWABE, Shizuoka (JP); Masahiro KIKUCHI, Shizuoka (JP)

(73) Assignee: Yazaki Corporation, Tokyo (JP)

(21) Appl. No.: 19/535,231

(22) Filed: Feb. 10, 2026

(30) Foreign Application Priority Data
Mar. 19, 2025 (JP) 2025-044443

(51) Int. Cl. H01R 13/52; H01R 13/506

(52) U.S. Cl. CPC H01R 13/5202; H01R 13/506

(57) ABSTRACT

A connector includes a housing fitted to a mating connector, a cover assembled to the housing, and a ring-shaped packing that stops water from flowing between the housing and the cover. The cover includes an inner wall part of an accommodation chamber that accommodates the packing. The housing includes an outer wall part of the accommodation chamber. The cover includes a deformation suppression part that suppresses deformation of the packing toward the outer wall part side, at a position on an outer peripheral side of the inner wall part.

### CROSS-REFERENCE TO RELATED APPLICATIONS

The present application claims priority to and incorporates by reference the entire contents of Japanese Patent Application No. 2025-044443 filed in Japan on March 19, 2025.

### BACKGROUND OF THE INVENTION

### 1. Field of the Invention

The present invention relates to a connector.

### 2. Description of the Related Art

For example, as described in JP 2022-181650 A, as a conventional connector, a connector with a cover attached to an opening part of a housing has been known. This connector includes a packing that stops water from flowing between the housing and the cover. The packing is disposed between two wall parts formed on the cover, and stops water from flowing between the connector and the housing.

In such a connector, there is room for improvement as the packing is not properly stop water flow in some cases. For example, in the connector described above, due to structural restrictions of the connector, there is no choice but to form a notch on the wall part for holding the packing. In this case, if the packing collapses or the like, there is a concern that the water flow between the housing and the cover cannot be stopped properly.

### SUMMARY OF THE INVENTION

Therefore, an object of the present invention is to provide a connector that can properly stop water from flowing between the housing and the cover.

In order to achieve the above mentioned object, a connector according to one aspect of the present invention includes a housing fitted to a mating connector; a cover assembled to the housing; and a ring-shaped packing that stops water from flowing between the housing and the cover, wherein one of the housing and the cover includes an inner wall part of an accommodation chamber that accommodates the packing, another of the housing and the cover includes an outer wall part of the accommodation chamber, and one of the housing and the cover includes a deformation suppression part that suppresses deformation of the packing toward the outer wall part side, at a position on an outer peripheral side of the inner wall part.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a connector according to an embodiment;

FIG. 2 is an exploded perspective view of the connector according to the embodiment;

FIG. 3 is an exploded perspective view of the connector according to the embodiment;

FIG. 4 is an enlarged view of a housing of the connector according to the embodiment;

FIG. 5 is an enlarged view of a cover of the connector according to the embodiment;

FIG. 6 is a perspective view of the cover and a packing of the connector according to the embodiment;

FIG. 7 is an explanatory view of a notch part and a locking mechanism of the connector according to the embodiment;

FIG. 8 is an explanatory view of a deformation suppression part of the connector according to the embodiment;

FIG. 9 is an explanatory view of an accommodation chamber of the connector according to the embodiment; and

FIG. 10 is an explanatory view of the pressure inside the connector according to the embodiment, and a diagram of the cover of the connector viewed from inside.

### DETAILED DESCRIPTION OF THE PREFERRED EMBODIMENTS

Hereinafter, an embodiment according to the present invention will be described in detail with reference to the accompanying drawings. However, the present invention is not limited to the embodiment. Moreover, components in the following embodiment include those that can be easily replaced by those skilled in the art, or those that are substantially the same.

### Embodiment

The present embodiment relates to a connector. In the following description, among a first direction, a second direction, and a third direction intersecting each other, the first direction is referred to as an "extending direction X", the second direction is referred to as an "arrangement direction Y", and the third direction is referred to as an "assembly direction Z". In this example, the extending direction X, the arrangement direction Y, and the assembly direction Z are orthogonal to each other. Note that orthogonal in this example includes substantially orthogonal. The extending direction X is the direction in which some electrical wires extend. The arrangement direction Y is the direction in which some electrical wires are arranged. The assembly direction Z corresponds to the direction in which a cover is assembled to a housing. Moreover, unless otherwise specified, each direction used in the following description refers to a direction in a state in which parts are assembled to each other.

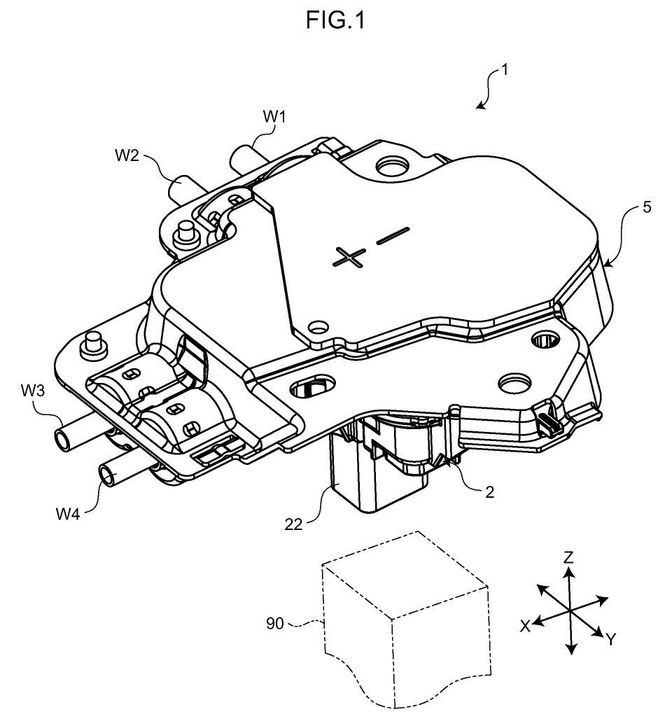

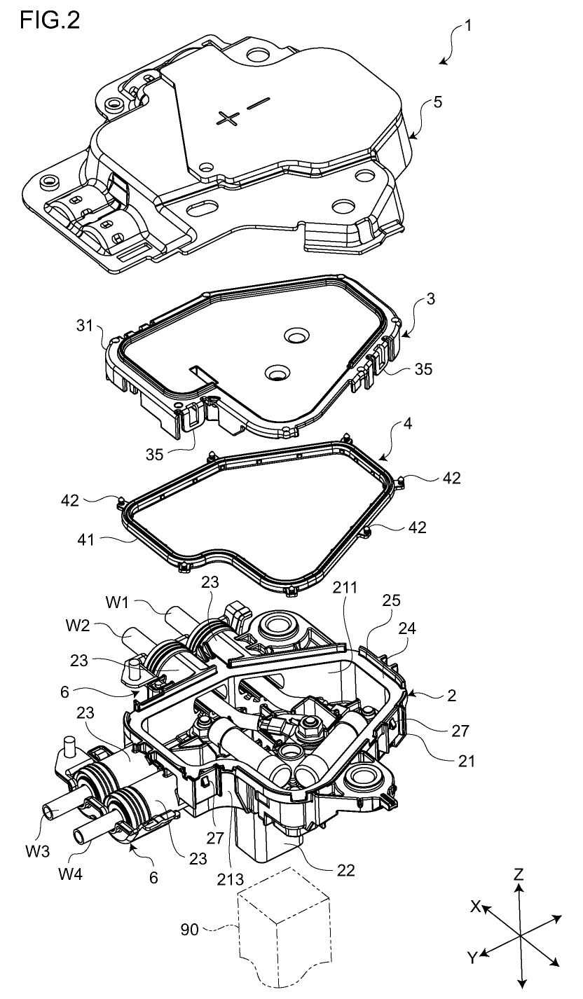

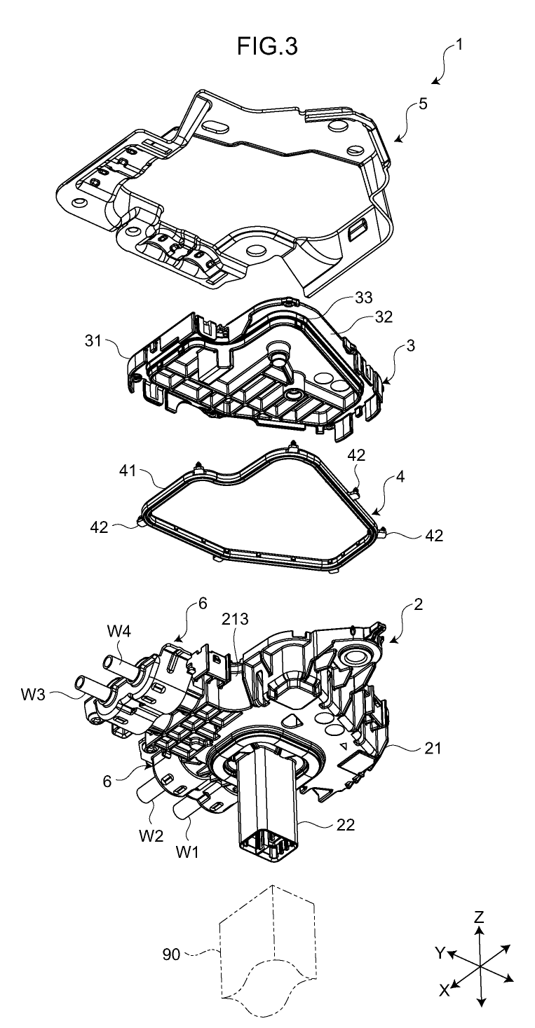

As illustrated in FIG. 1 to FIG. 3, a connector 1 is a component connected to a mating connector 90, and is, for example, mounted on a vehicle, and is used by being incorporated in a wire harness routed in the vehicle. In this example, for example, the wire harness is a collective component in which wiring materials used for power supply or signal communication are bundled together to connect devices mounted on the vehicle. The wire harness connects the wiring material to each of the devices via the connector 1 or the like. For example, the wire harness includes a plurality of electrical wires W1, W2, W3, and W4, the connector 1 into which the tip ends of the electrical wires W1, W2, W3, and W4 are drawn, and the mating connector 90 electrically and mechanically connected to the connector 1. In addition, the wire harness may also include various other components such as a grommet, a protector, and a fixture.

The connector 1 includes a housing 2, a cover 3, and a packing 4. For example, the housing 2 is a component fitted to the mating connector 90, and is formed of an insulating resin material. The housing 2 includes a housing main body 21, a fitting part 22, an electrical wire insertion part 23, and an engagement protrusion 27. The housing main body 21 is formed in a box-shape with an opening part 211. For example, the cross-sectional shape of the housing main body 21 in a direction intersecting the assembly direction Z is formed in a concave polygon shape, and part of a corner is formed as a concave corner 213. The interior angle of the concave corner 213 is greater than 180 degrees and less than 360 degrees. Specifically, the cross-sectional shape of the housing main body 21 in a direction intersecting the assembly direction Z has a concave heptagonal shape, and the housing main body 21 has the concave corner 213. The concave polygon includes a substantially concave polygonal shape, and the concave heptagon includes a substantially concave heptagonal shape. Moreover, in the housing main body 21, the length in the assembly direction Z is formed shorter than the extending direction X and the arrangement direction Y. The opening part 211 is formed such that one surface in the assembly direction Z of the housing main body 21 is opened. For example, the shape of the opening part 211 is shaped according to the cross-sectional shape of the housing main body 21, and is a concave polygon in which the interior angle of a corner is greater than 180 degrees and less than 360 degrees.

The fitting part 22 is provided so as to protrude from the housing main body 21 in the assembly direction Z. The fitting part 22 is formed in a square cylindrical shape extending toward the assembly direction Z. For example, a plurality of male terminals are provided inside the fitting part 22. The fitting part 22 connects the connector 1 with the mating connector 90, by fitting to the mating connector 90.

The electrical wire insertion part 23 protrudes from the side surface of the housing main body 21, and four electrical wire insertion parts 23 are provided according to the number of the electrical wires W1 to W4. The electrical wire insertion parts 23 are provided two by two in a direction intersecting each other. For example, two of the electrical wire insertion parts 23 protrude in the extending direction X, and two of the electrical wire insertion parts 23 protrude in the arrangement direction Y.

The engagement protrusion 27 is a protrusion that protrudes from the side surface of the housing main body 21, and a plurality of the engagement protrusions 27 are provided along the outer periphery of the housing main body 21 at intervals. The engagement protrusions 27 are each a protrusion that engages with an engagement arm 35 of the cover 3, and in a state in which the cover 3 is assembled to the housing 2, engages with the engagement arm 35 and locks the cover 3 to the housing 2.

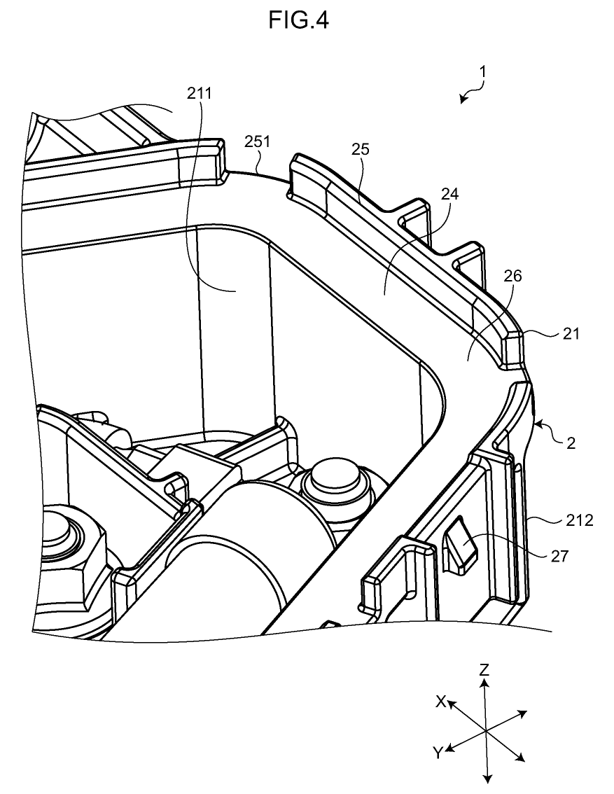

As illustrated in FIG. 4, the housing 2 includes a housing-side water-stopping surface 24 and an outer wall part 25. The housing-side water-stopping surface 24 and the outer wall part 25 are portions that are formed on the housing main body 21, that hold the packing 4, and that form an accommodation chamber 26 for the packing 4. The housing-side water-stopping surface 24 and the outer wall part 25 are formed along the outer edge portion of the opening part 211. The housing-side water-stopping surface 24 is a surface that spreads in a direction intersecting the assembly direction Z, and extends along the outer edge portion of the opening part 211. For example, the housing-side water-stopping surface 24 is formed on the upper end portion of a side wall 212 of the housing main body 21. The outer wall part 25 is a wall part erected from the housing-side water-stopping surface 24 toward the assembly direction Z. For example, the outer wall part 25 is provided at a position close to the outside of the housing-side water-stopping surface 24, and covers the outer peripheral side of the packing 4. In other words, the housing-side water-stopping surface 24 is formed in an L-shaped cross-section continuous to the outer wall part 25, and extends in a direction intersecting the assembly direction Z of the packing 4.

On the outer wall part 25, notch parts 251 are formed at predetermined intervals in the extending direction. Each of the notch parts 251 is a space through which a protruding piece 42 formed on the packing 4 is to be inserted.

In FIG. 1 to FIG. 3, the cover 3 is a lid member that covers the opening part 211 of the housing 2, and is formed according to the shape and size of the opening part 211. For example, the cover 3 is formed in a concave polygonal shape, and has a size that can cover the opening part 211, the housing-side water-stopping surface 24, and the outer wall part 25 of the housing 2.

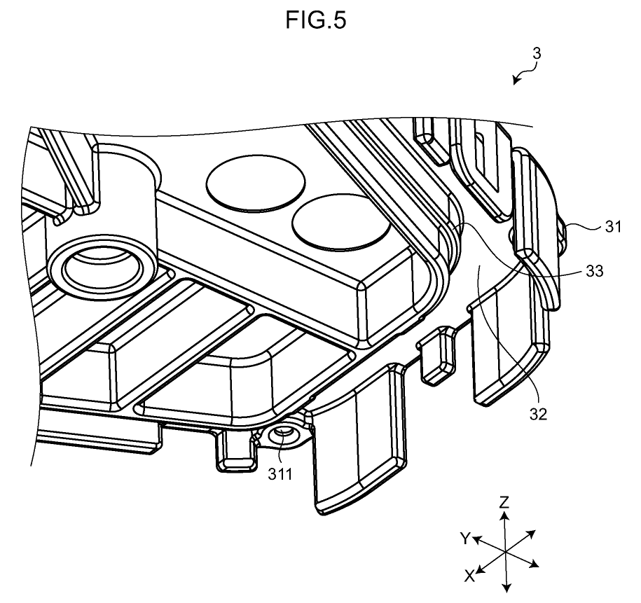

As illustrated in FIG. 5, the cover 3 includes a cover main body 31, a cover-side water-stopping surface 32, and an inner wall part 33. The cover main body 31 is a plate-shaped portion having a concave polygonal exterior. The cover-side water-stopping surface 32 and the inner wall part 33 are portions that are formed on the cover main body 31, that hold the packing 4, and that form the accommodation chamber 26 for the packing 4. The cover-side water-stopping surface 32 and the inner wall part 33 are formed along the outer edge portion of the cover main body 31. For example, the cover-side water-stopping surface 32 is a surface that are formed on the lower surface of the cover main body 31, that spreads in a direction intersecting the assembly direction Z, and that extends along the outer edge portion of the cover main body 31. The inner wall part 33 is a wall part hanging down in the assembly direction Z from the cover-side water-stopping surface 32. For example, the inner wall part 33 is provided at a position close to the inside of the cover-side water-stopping surface 32, and covers the inner peripheral side of the packing 4. In other words, the cover-side water-stopping surface 32 is formed in an L-shaped cross-section continuous to the inner wall part 33, and extends in a direction intersecting the assembly direction Z of the packing 4.

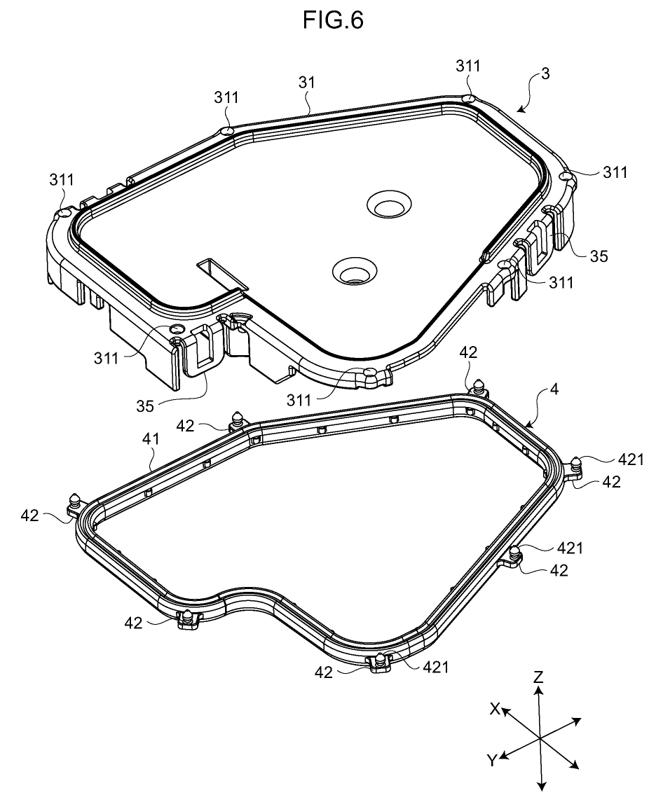

As illustrated in FIG. 6, the packing 4 is a water-stopping member that stops water from flowing between the housing 2 and the cover 3, and is formed in a ring shape using an elastic material such as rubber and elastomer. For example, the packing 4 is formed into a shape according to the shape of the opening part 211, and is formed in a concave polygonal ring shape. The packing 4 includes a packing main body 41 and the protruding piece 42. The packing main body 41 is a portion that functions as a water-stopping member, and is formed in a ring shape. The protruding piece 42 is a portion that protrudes to the ring-shaped outside from the packing main body 41, and a plurality of the protruding pieces 42 are provided at predetermined intervals. For example, the protruding pieces 42 engage with the cover 3, and restrict the movement of the packing 4 between the housing 2 and the cover 3. The protruding pieces 42 each include an engaging part 421 that protrudes toward the cover 3. The engaging part 421 engages with a part to be engaged 311 formed on the cover main body 31 of the cover 3, to fix the packing 4 to the cover 3. For example, the part to be engaged 311 is a hole through which the engaging part 421 can be inserted. A plurality of the parts to be engaged 311 are provided according to the installation number of the protruding pieces 42, and are provided at positions according to where the engaging part 421 is formed.

As illustrated in FIG. 1 to FIG. 3, the connector 1 includes an upper shell 5 and a lower shell 6. The upper shell 5 is a shielding member provided to cover the cover 3 and the housing 2. The upper shell 5 is a plate-shaped member, and is formed larger than the cover 3. The upper shell 5 is installed so as to overlap with the cover 3 from outside. The lower shell 6 is provided so as to cover the electrical wire insertion part 23. For example, two lower shells 6 are provided, and are installed so as to cover the electrical wire insertion parts 23 arranged two by two. The lower shell 6 is formed so that two circular arc parts are arranged, and covers the electrical wire insertion parts 23 so that the electrical wire insertion parts 23 are interposed between the lower shell 6 and the upper shell 5.

Next, a water-stopping structure of the connector 1 according to the present embodiment will be described.

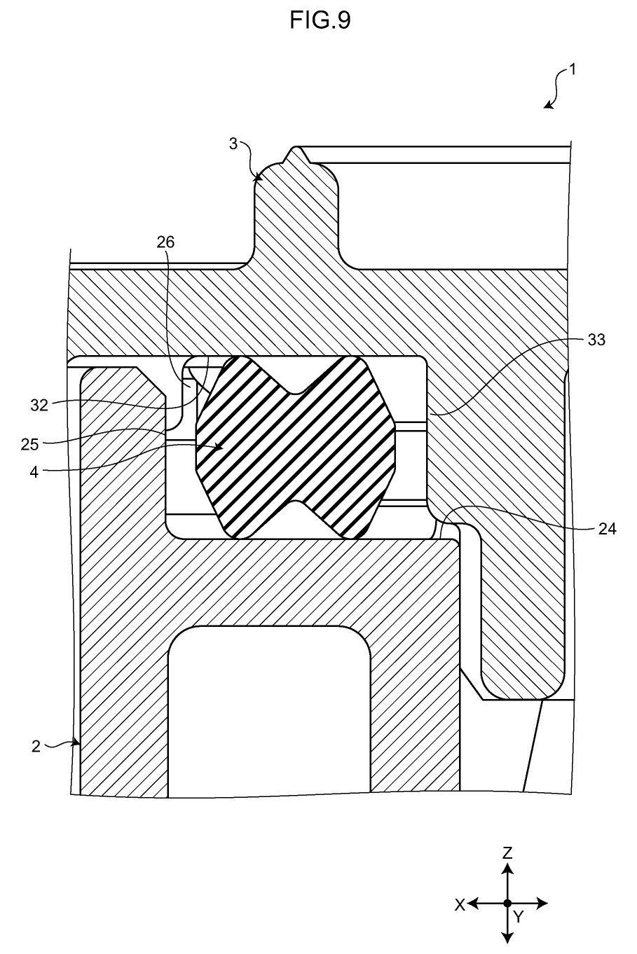

As illustrated in FIG. 9, the accommodation chamber 26 is formed by the housing 2 and the cover 3, and the packing 4 installed in the accommodation chamber 26 stops water from flowing between the housing 2 and the cover 3. In other words, when the cover 3 is assembled to the housing 2, in the connector 1, the accommodation chamber 26 with a labyrinth structure is formed by the outer wall part 25 and the housing-side water-stopping surface 24 of the housing 2, and the inner wall part 33 and the cover-side water-stopping surface 32 of the cover 3. The packing 4 is installed in the accommodation chamber 26, abuts to the housing-side water-stopping surface 24 and the cover-side water-stopping surface 32, and stops water from flowing between the housing 2 and the cover 3. In this manner, when the accommodation chamber 26 is assembled by the outer wall part 25, the housing-side water-stopping surface 24, the inner wall part 33, and the cover-side water-stopping surface 32, the packing 4 can properly stop the water flow, because the packing 4 is suppressed from collapsing to the inner wall part 33 side or the outer wall part 25 side.

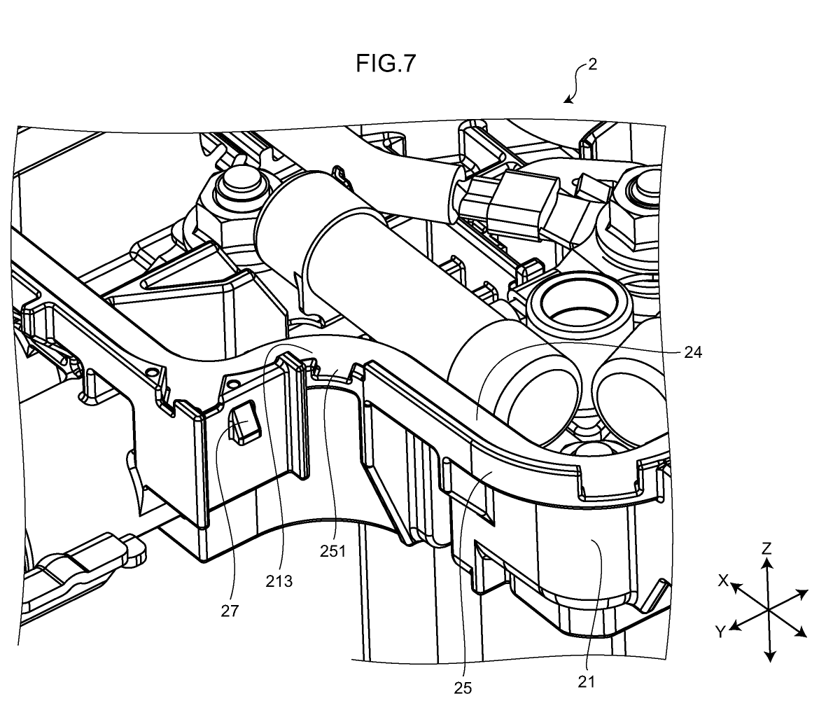

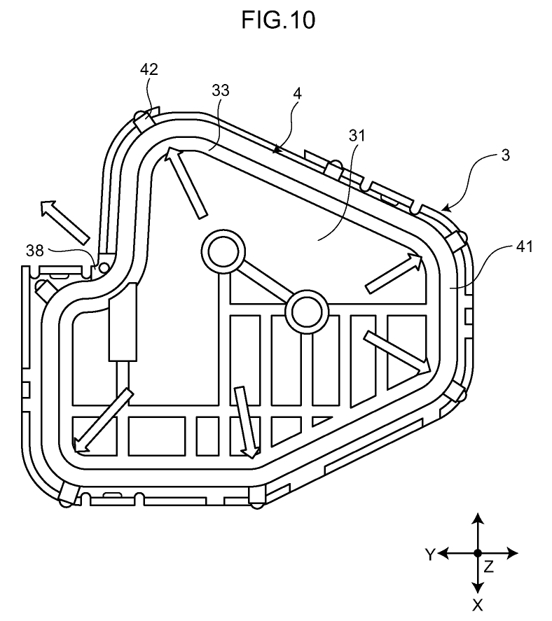

In this example, as illustrated in FIG. 7, in the connector 1, due to structural restrictions, a notch part 251 is formed on the outer wall part 25. The notch part 251 in FIG. 7 is a notch portion formed when the locking mechanisms of the engagement protrusion 27 and the engagement arm 35 are provided adjacent to each other. What is more, the notch part 251 is formed at the concave corner 213 of the housing main body 21. As illustrated in FIG. 10, when the pressure is applied from the inside of the connector 1, the packing 4 is pressed against the outside. Hence, there is a concern that the installation state of the packing 4 at the notched portion of the outer wall part 25 may not be appropriately maintained, due to the collapse or falling off of the packing 4.

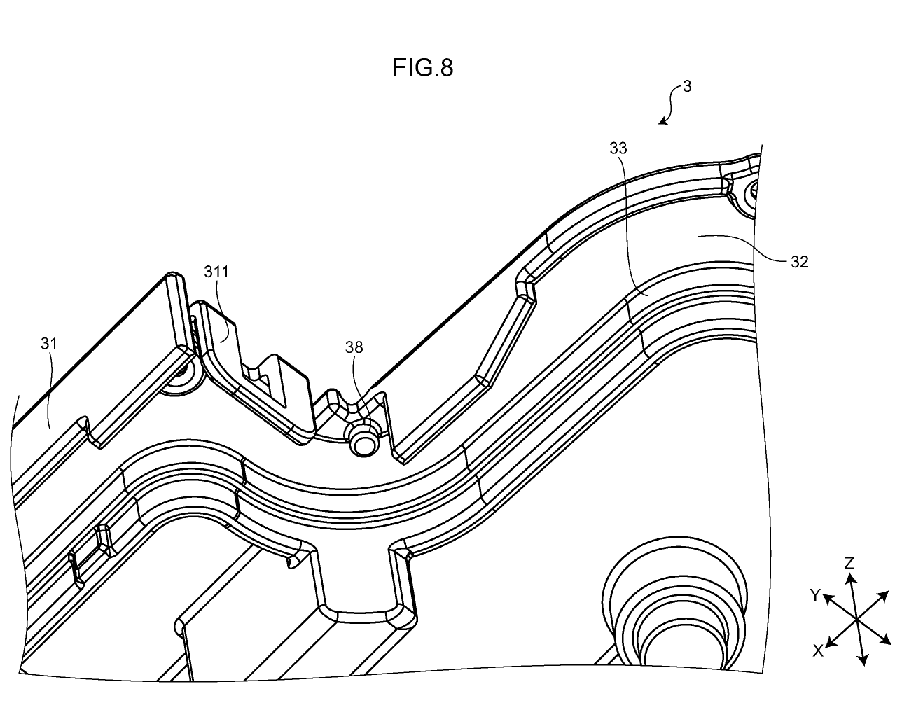

In contrast, in the connector 1 according to the present embodiment, a deformation suppression part 38 is formed at a position on the outer peripheral side of the inner wall part 33 of the cover 3. Hence, the packing 4 can properly stop the water flow, because the packing 4 can be maintained in an appropriate state. For example, as illustrated in FIG. 8, the deformation suppression part 38 is a protrusion that protrudes from a position in the vicinity of the cover-side water-stopping surface 32 of the cover 3, and is provided so as to be inserted into the notch part 251 in FIG. 7. In FIG. 8, the deformation suppression part 38 is illustrated as a cylindrical protrusion, but may also have a shape other than a cylindrical shape. The deformation suppression part 38 is provided outside the packing 4, and supports the packing 4 and suppresses the deformation of the packing 4, even if the packing 4 receives pressure from the inside of the connector 1, and moves outwardly or nearly collapses. Consequently, the packing 4 can properly stop the water flow, because the deformation suppression part 38 maintains the packing 4 in an appropriate state.

As described above, the connector 1 according to the present embodiment includes the deformation suppression part 38. Hence, it is possible to suppress the packing 4 from deforming outwardly, and the packing 4 can properly stop water from flowing between the housing 2 and the cover 3.

Moreover, in the connector 1 according to the present embodiment, the deformation suppression part 38 is formed at a position corresponding to the notch part 251 on the outer wall part 25. Hence, it is possible to precisely suppress the deformation of the packing 4 at a location where the packing 4 is easily deformed.

Furthermore, in the connector 1 according to the present embodiment, the notch part 251 and the deformation suppression part 38 are formed at the concave corner 213 of the housing 2. Hence, it is possible to precisely suppress the deformation of the packing 4 at the concave corner 213 where the packing 4 is easily deformed outwardly.

The connector according to the present invention is not limited to that in the embodiment described above, and various changes may be made within the scope of the claims. The connector 1 according to the present embodiment may be configured by appropriately combining the components of the embodiments and the modifications described above.

For example, in the connector 1 according to the embodiment described above, the outer wall part 25 is provided in the housing 2, and the inner wall part 33 is provided in the cover 3. However, the inner wall part 33 may be provided in the housing 2, and the outer wall part 25 may be provided in the cover 3. Even with such a connector, it is possible to obtain the same operational effects as those in the connector 1 described above, and by including the deformation suppression part 38, the packing 4 can properly stop water from flowing between the housing 2 and the cover 3.

Moreover, the connector 1 according to the embodiment described above is installed in a vehicle. However, the connector 1 may also be used for other things in addition to the vehicle.

With the connector according to the present embodiment, the packing can properly stop the water flow.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector, comprising:
a housing fitted to a mating connector;
a cover assembled to the housing; and
a ring-shaped packing that stops water from flowing between the housing and the cover, wherein
one of the housing and the cover includes an inner wall part of an accommodation chamber that accommodates the packing,
another of the housing and the cover includes an outer wall part of the accommodation chamber, and
one of the housing and the cover includes a deformation suppression part that suppresses deformation of the packing toward the outer wall part side, at a position on an outer peripheral side of the inner wall part.

2. The connector according to claim 1, wherein the deformation suppression part is formed at a position corresponding to a notch part obtained by notching a part of the outer wall part.

3. The connector according to claim 2, wherein the notch part and the deformation suppression part are formed at a concave corner of the housing.
